(19) United States
(12) Patent Application Publication
(10) Pub. No.: US 2012/0005069 A1
(43) Pub. Date: Jan. 5, 2012

(54) SYSTEM AND METHOD FOR ESTIMATING PERCEIVED QUALITY OF NEW PRODUCTS

(76) Inventors: Hyun Sang Shin, Wesbury, NY (US); In Soon Chang, Seoul (KR)

(21) Appl. No.: 13/256,807

(22) PCT Filed: Mar. 30, 2009
(86) PCT No.: PCT/KR09/01594

§ 371 Date: Sep. 15, 2011

(30) Foreign Application Priority Data
Mar. 19, 2009 (KR) 10-2009-0023334

(51) Int. Cl. G06Q 40/00

(52) U.S. Cl. 705/37

(57) ABSTRACT

A system and a method are provided, which allow participants to trade virtual stocks corresponding to a plurality of products including at least one new product, and which provide a normalized perceived quality value about each of the products. A plurality of participants is provided with virtual stocks corresponding to the plurality of products and also virtual currency and allowed to trade the plurality of virtual stocks with the virtual currency. The transactions are recorded in a trade log database and analyzed to estimate the perceived quality of the product corresponding to each virtual stock. Accordingly, it is possible to estimate and compare the perceived quality of a new product with that of the existing products, and thus, the price of the new product before launch can be set with increased ease.

### CROSS-REFERENCE TO RELATED APPLICATIONS

This application is a National Phase application, filed under 35 U.S.C. §371, of PCT Application No. PCT/KR2009/001594, filed Mar. 30, 2009, which claims the benefit of priority to Korean Patent Application No. 10-2009-0023334, filed on Mar. 19, 2009, the contents of which are incorporated herein by reference in their entirety.

### BACKGROUND

1. Field of the Invention

The invention relates to a system and a method for estimating the perceived quality of a new product in comparison with that of existing products, by enabling users to participate in trading of virtual stocks corresponding to a plurality of products including at least one new product in the virtual stock market, and by collecting and analyzing the trading data from the virtual stock market.

2. Description of the Related Art

The value of a business is estimated by the discounted net future cash flows from its products (i.e., goods, services, and ideas). The future cash flows in the competitive market depend on how attractive the business's products are when these are compared to the products of their rival companies. Accordingly, the perceived quality of a product estimated in comparison with that of the rival companies' products is regarded as an important reference to determine the value of the business.

However, it is very difficult to estimate the perceived quality of new products before they are actually launched on the market. Generally, a survey-based market research method has been conducted to estimate the perceived quality of a new product, in which participants are provided with the information about a new product and then respond to survey questionnaires. However, such a survey-based method is subject to individual-level bias. In order to avoid the individual-level bias and subsequently obtain an effective result representing the entire market's response, it is necessary to construct a large, representative sample. This means that survey-based market research can be costly and time-consuming. More importantly, if many people are surveyed, there is a higher risk that information about the new products will be leaked to the rival companies. This can lead to decreased profitability due to early release of similar or copy-cat products by the rivals.

Meanwhile, attempts have been made to invite users to participate in a virtual stock market and freely trade the virtual stocks for a predetermined time period, and acquire information related to the user's preference therefrom. The virtual stock market can eliminate the effects of individual-level bias derived from the individual's own characteristics including, for example, prejudices, unique preferences, and inadvertent responses due to fatigue or indifference, since arbitrage traders or marginal traders will focus on making profits from arbitrage transaction opportunities based on the incentive-compatibility of the stock market mechanism. Accordingly, it is possible to obtain useful information through the virtual stock market about the customer's preferences on the products without having to construct a large, representative sample.

While the virtual stock market can provide general information on the overall customer preferences, it is difficult to measure the perceived quality of a new product in comparison with other products in specific numbers based on scientific analysis of data from the virtual stock market. Accordingly, it is still difficult to determine the initial price of a new product by using the transaction results from the virtual stock market.

Therefore, a method is necessary, which is capable of not only utilizing the virtual stock market to obtain effective result even with a small number of samples, but also of measuring the perceived quality of a new product in specific numbers in comparison with that of the other existing products, to thereby provide a useful reference to determine initial price of the new product.

### SUMMARY

The invention provides a system and a method for estimating perceived quality of a new product before launch, even with a small number of participants in a short time span.

According to the present invention, a system and a method are provided, which can measure the perceived quality of the new product and existing products using normalized figures, and thus be utilized for determining initial price of the new product.

A system for estimating the perceived quality of a new product in one embodiment may include 1) a participant information database which stores therein the amount of virtual currency and the number of virtual stocks owned by each of a plurality of participants, 2) a trade log database which stores therein records of the transactions of the virtual stocks corresponding to each of a plurality of products, 3) a virtual stock trading unit which receives an order to sell/buy the virtual stocks from terminals of the plurality of participants; after transactions are completed according to the received orders to sell/buy, it records the results of the transactions including information such as types of products corresponding to the virtual stocks of the completed transactions, the trading price, and the amount of stocks traded in the trade log database, and updates the participant information database according to the completed transactions, 4) a trade analysis module which estimates a market consensus price of each of the virtual stocks by carrying out a regression analysis using the records of the transactions stored in the trade log database, and 5) an analysis result providing unit which normalizes the market consensus price and provides a user with the result of normalized perceived quality information.

The trade analysis module may include a trade information-processing unit which obtains the price differentials of a specific transaction, by computing a difference between a trading price and a volume-weighted average price of all the transactions from the initial to the specific transactions. The market consensus price of each of the virtual stocks is estimated by carrying out regression analysis using the trading price and the price differential of each of the transactions of the virtual stocks corresponding to the respective products.

The trade analysis module may estimate the market consensus price of a virtual stock based on the intercept value which is obtained by carrying out regression analysis of the trading prices of the respective transactions of the virtual stock corresponding to the product and the price differential of the transaction immediately before the specific transaction.

The trade analysis module may estimate the market consensus prices of the respective virtual stocks by carrying out the regression analysis using the trading prices of the respective transactions of the virtual stocks corresponding to the products, the trading price of the transaction immediately before the specific transaction, the price differential of the transaction immediately before the specific transaction, and the price differential of the transaction immediately before the previous transaction.

The trade analysis module may obtain value α by estimating [Mathematical expression 1].

Pₜ=(1−ρ)·α+ρ·Pₜ₋₁+γ·(DIFFₜ₋₁−ρ·DIFFₜ₋₂)+v_{i,t} [Mathematical expression 1]

where Pₜ refers to the trading price of the (t) th transaction, and DIFFₜ refers to the price differential of the (t) th transaction, and estimate the value α as the market consensus price of the virtual stock.

In one embodiment, the system may additionally include a product information database which stores therein product information (e.g., safety, number of seats, mileage for a car) regarding the plurality of products, and an information providing unit which receives from the terminals of the participants a request for the product information of one of the plurality of products or the information of the transactions of the virtual stock corresponding to the product, and as a response, checks the product information database or the trade log database for the product information or the information of the transactions and sends the information to the terminals of the participants.

In one embodiment, a method for estimating the perceived quality of a new product may be provided, which may include storing in a participant information database the amount of virtual currency and the number of virtual stocks corresponding to each of a plurality of products owned by each of a plurality of participants, receiving an order to sell/buy the virtual stocks from terminals of the plurality of participants, and if transactions are completed according to the received orders to sell/buy, keeping the records of the transactions including information such as types of products corresponding to the virtual stocks of the completed transactions and the price and the amount of stocks traded in a trade log database, updating the participant information database according to the completed transactions, estimating a market consensus price of each of the virtual stocks by carrying out a regression analysis using the records of the transactions stored in the trade log database, and normalizing the market consensus price and providing a user with a normalized perceived quality information.

The process of estimating the market consensus price of each of the virtual stocks may include obtaining the price differential of a specific transaction, by obtaining a difference between a trading price of the specific transaction and a volume-weighted average price of all the transactions from the initial to the specific transaction, and carrying out regression analysis using the trading price and the price differential of each of the transactions of the virtual stocks corresponding to the respective products.

According to the present invention, it is possible to estimate the perceived quality of a new product before launch.

Further, according to the present invention, it is possible to measure the perceived quality of a new product measured in normalized numbers, thereby enabling estimation of the perceived quality of the new product in specific figures in comparison with the perceived quality of the existing products.

Further, according to the present invention, it is possible to measure the perceived quality of the new product after controlling for the influence of individual-level bias even with a small number of participants.

Further, according to the present invention, it is possible to obtain an effective result of estimating the perceived quality of a new product within a short period of time.

### BRIEF DESCRIPTION OF THE DRAWINGS

The above and/or other aspects of the present inventive concept will be more apparent by describing certain exemplary embodiments of the present inventive concept with reference to the accompanying drawings, in which:

FIG. 1 schematically illustrates a system for estimating the perceived quality of a new product, according to an embodiment;

FIG. 2 illustrates an internal structure of a system for estimating the perceived quality of a new product, according to an embodiment;

FIG. 3 illustrates a trade log listing transactions of the virtual stocks by the participants using the system for estimating the perceived quality of a new product, according to an embodiment;

FIG. 4 illustrates an example of normalized perceived quality of a new product, which is estimated using the system for estimating the perceived quality of a new product, according to an embodiment;

FIG. 5 illustrates a screen provided by the system for estimating the perceived quality of a new product, according to an embodiment, providing a user with information about the products corresponding to the virtual stocks; and

FIG. 6 is a flowchart provided to explain a method for estimating the perceived quality of a new product, according to an embodiment.

### DETAILED DESCRIPTION OF EXEMPLARY EMBODIMENTS

Certain exemplary embodiments of the present inventive concept will now be described in greater detail with reference to the accompanying drawings. However, the present inventive concept is not limited or restricted by the embodiments. In the following description, the same drawing reference numerals are used for the same elements, even in different drawings.

A system for estimating the perceived quality of a new product according to an embodiment includes a central processing unit (CPU) and a memory, and may be configured in a server form which is connectible to another terminal via a communication network including the internet. However, the invention is not limited to the construction of CPU or memory. Further, the system may be configured as one single server, or distributed over a plurality of servers, although not limited thereto. The ‘server’ herein corresponds to a terminal, and should not be understood as a concept opposed to a personal computer (PC). Accordingly, a variety of configurations of server is possible. For example, a PC can be used as a small-scale server.

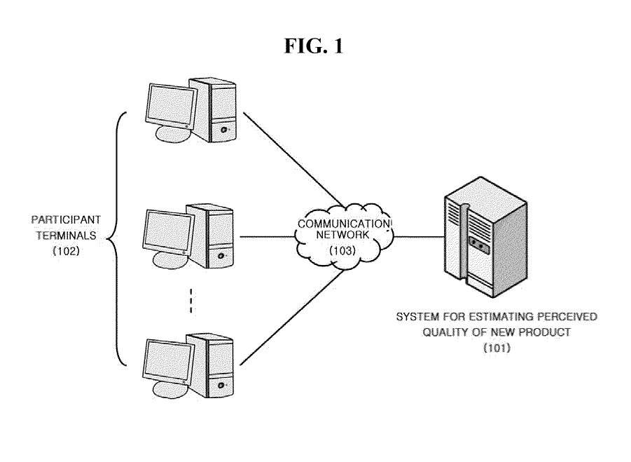

FIG. 1 schematically illustrates the system 101 for estimating the perceived quality of a new product, according to an embodiment.

Referring to FIG. 1, the system 101 can be connected to terminals 102 of participants via a communication network 103. As discussed above, the system 101 may be configured into a server form which is accessible from other terminals, and should not be limited based on the configuration thereof.

The communication network 103 may encompass an open network such as the Internet, or a closed network such as an intranet. The communication network 103 may take any form, provided that the communication network 103 is connected to enable transmission and reception of data between the system 101 and the terminals 102 of the participants. The communication network 103 may be a wired or wireless network.

According to the present invention, the participants access the system 101 through the terminals 102, check information on the products and records of virtual stock trading, and input a transaction order for the virtual stock which is transmitted to the system 101. The terminals 102 may be configured in the same form as a PC, or any forms of terminals, including mobile phones or PDAs, which can connect to the communication network 103.

A separate client program may be installed on the terminals 102 to receive information about the products and trading from the system 101, provide the received information to the users, and transmit in real-time the transaction orders to the system 101. The information may be received and transaction orders may be transmitted according to HTTP protocol using programs such as web browsers.

The participants accessing the system 101 using the terminals 102 may include a variety of people who could be the respondents if the conventional survey-based research is conducted. However, the present invention can provide effective estimation of the perceived quality of a new product using a relatively smaller number of participants. Further, compared to the conventional survey-based research which selects participants by considering various factors such as gender, age, or location to avoid discrepancy in the result of survey due to individual-level bias, the present invention automatically eliminates abnormal results caused due to individual-level bias. Accordingly, the present invention provides for easier selection of participants.

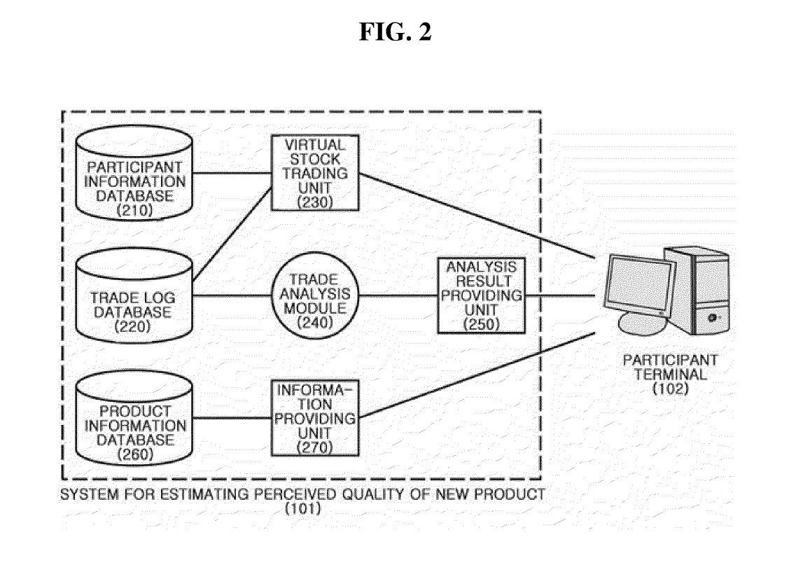

FIG. 2 illustrates an internal structure of a system for estimating the perceived quality of a new product, according to an embodiment.

Referring to FIG. 2, the system 101 according to an embodiment of the present invention may include a participant information database 210, a trade log database 220, a virtual stock trading unit 230, a trade analysis module 240, an analysis result providing unit 250, a product information database 260 and an information providing unit 270. These components may be implemented in software, hardware or a combination of the software and the hardware, and connectible to each other. Each of the components will be explained in detail below.

The participant information database 210 stores therein an amount of virtual currency and a number of virtual stocks corresponding to a plurality of products including at least one new product owned by each of a plurality of participants. As explained above, the system 101 allows a plurality of participants to access the system 101 through their terminals and trade virtual stocks corresponding to a plurality of products. The plurality of products may include at least one new product, and a plurality of existing products relevant to the new product. Since the new product is compared with the relevant existing products, it is possible to analyze the relative perceived quality.

The virtual stocks correspond to the plurality of products, respectively. If necessary, a plurality of virtual stocks may be issued corresponding to the attributes of one product (e.g., a plurality of virtual stocks may be issued with respect to one product based on its elements such as brand, color, function, or design). The participant information database 210 may also store the same number of virtual stocks corresponding to the respective products as well as the same amount of virtual currency for respective participants before the trade of virtual stocks begins, so that all the participants may begin trading virtual stocks under the same initial conditions. Depending on a researcher's needs, the participants may initially be given different amounts of virtual stocks or currency.

The trade log database 220 stores trade log of the virtual stocks. The trade log may include information about the transactions completed among the participants. For example, the trade log may include the type of the virtual stocks traded (i.e., information about the product corresponding to the virtual stock), or the amount or price of the virtual stocks traded. Additionally, the trade log may include a variety of information including the buyer, seller, or time of transaction.

The participant information database 210 and the trade log database 220 may be implemented using commercially-available DBMS such as Oracle and MySQL DB2, although not limited thereto. Accordingly, the participant information database 210 and the trade log database 220 may be implemented using any storage devices that can store and search data, or any programs that can be implemented through storage devices that store and manage the data.

The virtual stock trading unit 230 may receive orders to sell/buy the virtual stocks from the terminals 102 of the plurality of participants, and if a transaction is completed according to the received order to sell/buy, store the records of the transactions such as the type of the products corresponding to the virtual stocks as traded, the price or amount of the virtual stocks as traded, into the trade log database 220, or update the participant information database 210 according to the records of the completed transactions.

The order to sell/buy a virtual stock received at the virtual stock trading unit 230 from the terminals 102 of the participants may include the type of the virtual stock to be traded (i.e., information about the product corresponding to the virtual stock), or the amount or price of the virtual stocks to be traded. It may be set so that the order to sell/buy can be cancelled before the transaction is completed, and cannot be canceled after the transaction is completed.

Herein, the transaction is completed at the virtual stock trading unit 230 according to the order to sell/buy, that is, the transaction is completed when different participants transmit orders to sell/buy a specific virtual stock and the price offered by the order to sell is lower than or equal to the price offered by the order to buy. In this example, the transaction may be settled for the virtual stock in an amount corresponding to the smaller amount between the seller's order and buyer's order. If the price offered by the order to sell is same as the price offered by the order to buy, the price is settled at the corresponding amount; otherwise, the price may be settled at the amount by the order submitted first. However, the invention is not limited by the example of the transaction settlement rule explained above, and any type of transaction settlement rule may be implemented, provided that there is a certain rule to govern the transactions and that the participants understand the rule.

The trade log is stored in the trade log database 220 when the transaction is settled at the virtual stock trading unit 230. As explained above, the trade log may include various information including the type of the virtual stock traded (i.e., information about the product corresponding to the virtual stock), or the amount or price of the virtual stocks traded, and additionally, information regarding the time of transaction, buyer or seller.

Further, the participant information database 210 is updated when the transaction is completed at the virtual stock trading unit 230 in a manner decreasing the number of virtual stocks corresponding to the amount of the transaction on the part of a seller who transmitted an order to sell, while increasing the number of virtual stocks corresponding to the amount of the transaction on the part of a buyer who transmitted an order to buy. Additionally, for the seller, the amount of virtual currency increases as much as the amount of transaction multiplied by the price as set, while the amount of virtual currency decreases for the buyer as much as the amount of transaction multiplied by the price as set. Since the result of transaction is reflected in the participant information database 210, the participants can see the latest result on a real-time basis and trade virtual stocks as if they actually participate in real stock trading.

The virtual stock trading unit 230 may be configured so that the virtual trading occurs exclusively within a predetermined time period. The predetermined time period may be long enough to find a market consensus price of a virtual stock based on the transactions of the virtual stock, and accumulate sufficient trade log data to estimate the perceived quality of respective products. The trading time period may be set during a trading session according to the degree of convergence, that is, when the transaction price converges toward the market consensus price as the transactions continue.

If the transaction completes at the virtual stock trading unit 230, the participant information database 210 is analyzed, and based on the amount of virtual currency and amount of virtual stocks in possession of the respective participants, the performance of transaction of each participant is computed. The corresponding participants may be rewarded for this performance. Such a reward system will motivate the participants to buy the virtual stocks at a price as low as possible and sell the virtual stocks at a price as high as possible. Accordingly, a participant will attempt to make profit from a transaction when the price seems significantly different from the reasonable value of a virtual stock from his/her perspective. As a result, the price of the virtual stock converges to its market consensus price, while individual level biases due to particular individual differences are eliminated.

The trade analysis module 240 carries out regression analysis using the records of transactions recorded in the trade log database 220 to estimate the market consensus price of the respective virtual stocks. The market consensus price refers to a market clearing price (or market equilibrium price) determined in the virtual stock market, in which the trading prices of a virtual stock converge to a certain value over time. To estimate the market consensus price, one can use the average price of the trading as a proxy of the market consensus price, relying on methods such as simple average, moving average, volume-weighted average, etc. However, the above methods may suffer the drawback of arriving at a result which deviates from the true market consensus price due to a few particular abnormal transactions (or outliers).

Accordingly, the trade analysis module 240 allows us to obtain more accurate market consensus price by analyzing the records of the transactions of the trade log database 220. To be specific, the market consensus price may be estimated by establishing a model, and carrying out a regression analysis with respect to the established model using the transaction records stored in the trade log database 220.

In one embodiment, which may be implemented to estimate the market consensus price based on the regression analysis on the model established at the trade analysis module 240, the model is first established to analyze the transaction records stored in the trade log database 220. A trade of a virtual stock carried out at the virtual stock trading unit 230 is influenced by the information about the product itself and the price set in the previous transaction. Accordingly, the market consensus price can be estimated as follows:

First, estimating the market consensus price by using the information about the product itself is similar to the survey-based market research in marketing. In survey-based market research, the survey result may take the form of normal distribution with the market consensus price as the mean. Therefore, one can analyze survey result using the following formula:

Pᵢ=αᵢ+vᵢ, vᵢ˜iid(0,δᵢ²) [Mathematical expression 2]

where, i refers to the type of virtual stock (that is, the product corresponding to the virtual stock), P is the result of survey, α is the parameter representing market consensus price, and v is the residual term which is independently and identically distributed with mean zero and variance δᵢ².

Second, estimating the price of the next trade based on the price of the previous trade is similar to analyzing the pattern of the trades occurred in the real stock market. Real stock price data can be modeled using the following formula:

P_{i,t}=P_{i,t-1}+vᵢ, vᵢ˜iid(0,δᵢ²) [Mathematical expression 3]

where t denotes a sequence of trade, Pᵢ is the firm i's stock price of a corresponding trade in the real stock market, and v is the residual term which is independently and identically distributed with mean zero and variance δᵢ².

Accordingly, in the system 101 for estimating the perceived quality of a new product according to an embodiment which is influenced by the product information and log data of the previous trades, a new model can be established in a combination of mathematical expressions 2 and 3, in which expression 2 represents a survey data analysis model (or “marketing model”) while expression 3 represents a stock market data analysis model (or “finance model”). Accordingly, [Mathematical Expression 4] is developed to analyze data from the virtual stock market as follows:

P_{i,t}=αᵢ+ρ˜P_{i,t-1}+vᵢ, vᵢiid(0,δᵢ²), |ρ|<1 [Mathematical expression 4]

where i refers to the type of virtual stock (that is, the product corresponding to the virtual stock), t denotes a sequence of trade, P is the virtual stock price of a corresponding trade, ρ captures the impact of the previous price on the current price, and αᵢ refers to the market consensus price of a virtual stock i, reflecting unobservable fundamental value of the corresponding product as in the example of expression 2.

It is also expected that, when the profit-maximizing participants find a difference between the fundamental value of the virtual stock of interest and the previous trading price, they will see this as an opportunity for arbitrage transactions, and accordingly, utilize the information for the virtual stock trading. As a result, more accurate estimation is obtained by considering the difference between previous transaction price and the volume-weighted average price (VWAP), which can represent the fundamental value of the virtual stock. The VWAP is obtained by applying a weight to all the previous transactions according to the volume of trading and computing an average therefrom. Here the VWAP is used as a proxy for the fundamental value, but other measurement, such as average price or median price, may also be used as another proxy for the fundamental value of the virtual stock. Applying the concept of DIFF (i.e., price differential) between the trading price and the VWAP to [Mathematical expression 4], we can obtain the following [Mathematical expression 5].

P_{i,t}=αᵢ+ρ·P_{i,t-1}+γᵢ·DIFF_{i,t-1}+uᵢ, uᵢ˜iid(0,δᵢ²), |ρ|<1 [Mathematical expression 5]

Since it is possible to obtain the trading prices (P_{i,t}) and the price differentials (DIFF_{i,t-1}) with respect to specific virtual stocks by analyzing the data recorded in the trade log database 220, it is also possible to carry out regression analysis using such data and obtain value (αᵢ) representing the market consensus price from the above expression.

Herein, a conventional regression analysis may be implemented. For example, with respect to expression 5, it may be difficult to carry out estimation and quantitative analysis using the ordinary least square method (OLS) due to cross-orthogonality problem. To resolve the above problem, expression 5 may be rewritten by adding an autoregressive term as follows:

P_{i,t}=αᵢ+γᵢ·DIFFₜ₋₁+e_{i,t}, e_{i,t}=ρ·e_{i,t-1}+v_{i,t}, v_{i,t}˜w.n(white noise process) [Mathematical expression 6]

By expanding the expression 6, we obtain:

P_{i,t}=(1−ρ)·αᵢ+ρ·P_{i,t-1}+γᵢ·(DIFF_{i,t-1}−ρDIFF_{i,t-2})+v_{i,t} [Mathematical expression 7]

As explained above, the trading prices (P_{i,t}) and the price differentials (DIFF_{i,t-1}) can be obtained by using the data recorded in the trade log database 220, and the market consensus price can be estimated based on the expression 7 using conventional regression analysis. By way of example, in order to resolve the cross-orthogonality related problems, estimation may be made after Cochrane-Orcutt data conversion by using the generalized least square method (GLS) or nonlinear least squares estimation method (NLS). The invention is not limited to particular regression analysis, and any method can be implemented, provided that it is capable of estimating the market consensus price (αᵢ) adequately.

The analysis result providing unit 250 normalizes the market consensus price estimated at the trade analysis module 240 and provides the user with the normalized perceived quality of the respective products. The normalization may be carried out with respect to the market consensus price of the virtual stock having the lowest market consensus price as estimated, and through the normalization, the user can obtain and compare the perceived quality among the respective products represented by the virtual stocks.

The analysis result providing unit 250 may use a display device directly added to the system 101 for analyzing the perceived quality of a new product to provide the user with information about the perceived quality. Alternatively, the user may access a separate terminal to check the information about the perceived quality, or emails or other means may be used to provide the above-mentioned information. However, the invention is not limited to these specific examples of information providing methods.

The product information database 260 stores product information about the plurality of products. As explained above, the system 101 allows the participants to check basic information about the products and participate in the trading based on such information. Accordingly, it is necessary to provide the basic information about the products represented by the virtual stocks in the virtual stock market. To this end, the product information database 260 may store product information therein, but the types of the recording device or method of recording are not specifically limited, provided that the product information database 260 can store the data in the form that can be provided to the participants.

Further, researchers may permit the participants to directly make changes in the data of the product information database 260 or directly issue virtual stocks using the information of the product information database 260. By way of example, the participants may be allowed to design a new product using information such as brand, design, color or function stored in the product information database 260, and the content may be recorded in the information providing unit 270. The virtual stock issued based on such product may be allowed to be listed on the virtual stock trading unit 230 and traded by the other participants.

It is possible to estimate the perceived quality of the new product using the drawn market consensus price and this can provide imperative information for the commercialization of the corresponding product. That is, the inventor of the corresponding product may obtain material resources and/or manpower and raise funds based on the perceived quality information, and the estimated perceived quality measured from the future customers' perspectives can be used as the core information in the distribution of interests or profit sharing among various contributors (i.e., inventors, producers, facility providers, investors, marketing planners, salesman, etc.) who are engaged in the design, development, production and sales of the corresponding product.

The information providing unit 270 receives from a terminal of a participant a request for the information about one of a plurality of products or about trading of the virtual stock corresponding to the product, and as a response, checks the trade log database 220 for the product information or the trading information and sends the information to the terminal of the participant. As a result, the participant is always able to check the trade log and the product information. Additionally, since machine learning is possible based on the analysis result of transaction data, trading between a participant and a computer can be carried out in a manner as predicted in the established model, which allows us to gather information on that participant's personal preferences as well as his/her response parameter to price changes or different types of product information.

The invention is also able to estimate the perceived quality of each attribute of a product. To be specific, each participant can be allowed to freely combine the attributes (e.g., brand, color, design, function, etc.) and design a new product concept, so that the perceived quality of the product concepts proposed by participants can be evaluated and compared according to the invention; based on the result, a product concept with superior perceived quality can be selected and developed for the commercialization of the idea. Herein, since the perceived quality of the selected product can be provided objectively, the information can be efficiently used for obtaining necessary economic resources and human/material resources. In other words, based on the invention, a company may reorganize the production or other related works by focusing on the products which are predicted to be more popular or successful among potential customers.

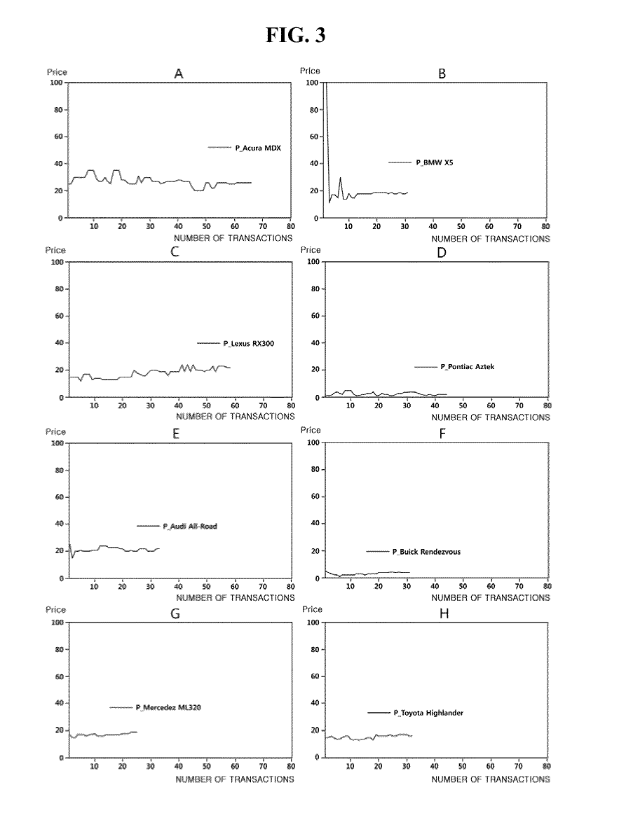

FIG. 3 illustrates the records of the transactions by the participants using a system for estimating perceived quality of a new product according to an embodiment.

To be specific, FIG. 3 is a graphical representation of price movement patterns of the virtual stocks representing cross-over utility vehicles (CUV) which are traded in the virtual stock market. As illustrated, once the trading of virtual stocks begins, the prices converge into market consensus price over time. Therefore, it is possible to measure the perceived quality of the products represented by the virtual stocks by estimating the market consensus price using the system for estimating the perceived quality of a new product.

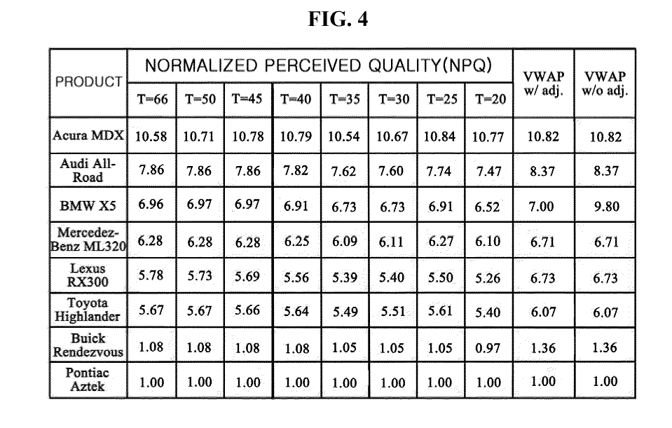

FIG. 4 illustrates an example of a normalized perceived quality of a new product which is estimated using the system according to an embodiment of the present invention.

As illustrated, the system for estimating the perceived quality of a new product according to an embodiment provides the normalized perceived quality based on the standard product, and thus, it is possible to analyze the whereabouts of the perceived quality of a new product before launch (i.e., the competitive position of the new product) in comparison with that of the existing product already on market.

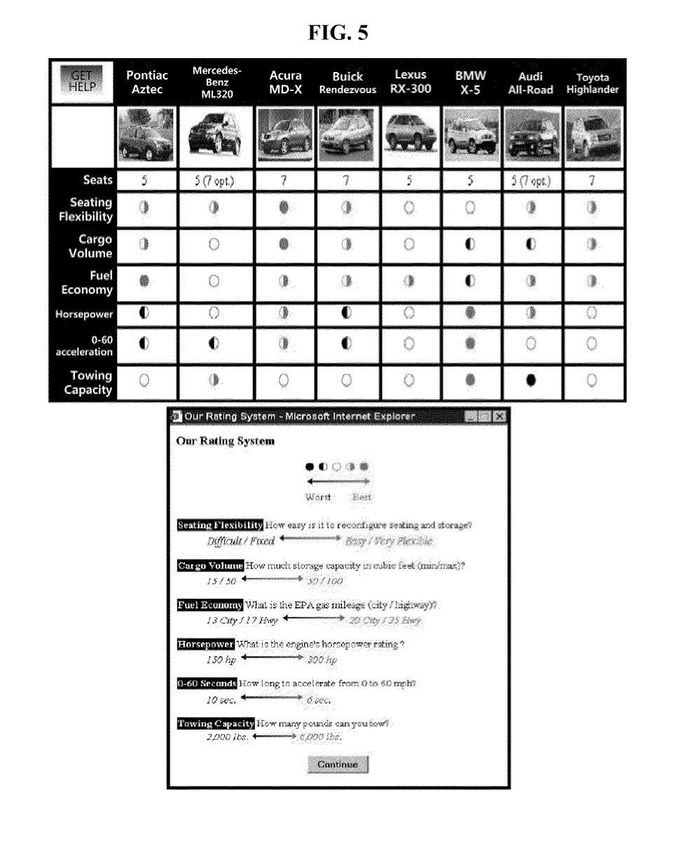

FIG. 5 illustrates an example of a screen provided by the system for estimating the perceived quality of a new product according to an embodiment to give a user the information about a product corresponding to a virtual stock.

As illustrated in FIG. 5, the participants can obtain through the screen various information about products (e.g., the number of seats, fuel economy, horse power, and pictorial information for 8 CUV products), use this information as basic data to assess the fundamental value of the products, and trade the corresponding virtual stocks accordingly. Since information about the products as well as the records of transactions of the virtual stocks corresponding to the respective products are provided to the participants, the system for estimating the perceived quality of a new product can analyze the trade log and measure the perceived quality of the product. The product information is not limited to those illustrated in the drawing, and the participants may freely refer to the product information as necessary to use it in the trading.

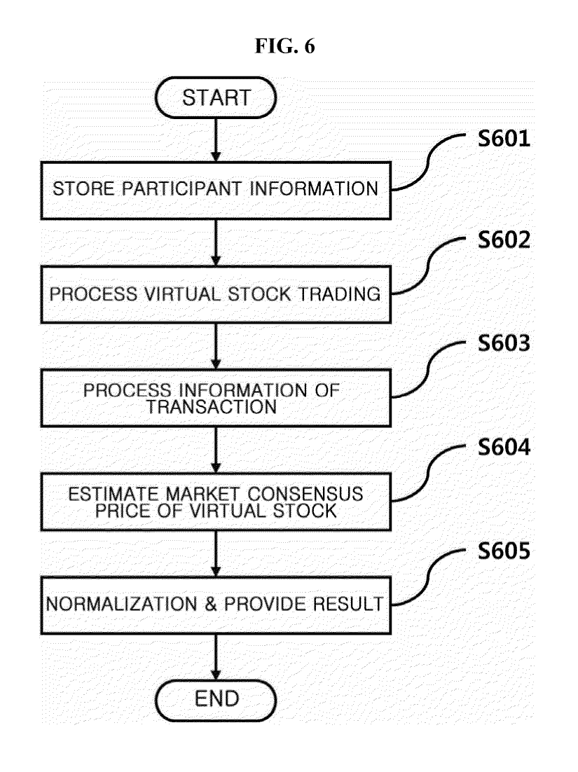

FIG. 6 is a flowchart illustrating a method for estimating the perceived quality of a new product according to an embodiment.

At S601, an amount of virtual currency in possession of each of a plurality of participants, in pair with a number of virtual stocks corresponding to each of a plurality of products in possession of each participant, are matched to each of corresponding participants and stored in the participant information database. At S602, orders to sell/buy the virtual stocks are received from the terminals of the plurality of participants, and when transactions are completed according to the received orders to sell/buy, trade log including information such as types of products corresponding to the virtual stocks of the completed transactions, or price or amount of stocks traded, is stored in the trade log database, and the participant information database is updated according to the completed transactions.

At S603, when the trading of the virtual stocks is completed, the trade log is processed to analyze the records of the trading stored in the trade log database. As explained above, in order to analyze the records of the trading, with respect to the entire transactions, differences can be obtained between the trading prices and the volume-weighted average prices of every transaction from the initial transaction to the above-mentioned transaction.

At S604, the market consensus prices of the respective virtual stocks are estimated by carrying out regression analysis using the trading prices and the price differentials of the respective transactions of the virtual stocks corresponding to the respective products. At S605, the market consensus prices are normalized and provided as the normalized perceived quality to the user. The normalization may be carried out with respect to the market consensus price of the virtual stock having the lowest market consensus price as estimated, and through the normalization, the user can determine and compare the perceived quality among the respective products represented by the virtual stocks.

The method for estimating the perceived quality of a new product according to an embodiment may be implemented in program forms executable through a variety of computing means and recorded on a computer-readable medium. The computer-readable medium may encompass program commands, data files, or data structure either individually or in combination. The program commands recorded on the medium may be the one that is specifically designed and constructed for the invention, or the one that is generally known and used among those skilled in the field of computer software. Examples of computer-readable recording media encompass magnetic media such as hard disks, floppy disks, or magnetic tapes; optical media such as CD-ROMs, or DVDs; magneto-optical media such as optical disks; and hardware devices such as ROM, RAM, or flash memory which is designed specifically to store and execute the program commands. The example of the program command includes not only machine codes generated by the compiler, but also high-level language codes executable by the computer through the use of an interpreter or the like. The hardware device may be implemented to operate as more than one software module to carry out the operations according to the invention, and vice versa.

While the limited embodiments and drawings have been explained above, the invention is not limited to the provided embodiments only, and those skilled in the art will be able to add modifications or variations based on the disclosure.

Therefore, the scope of the invention should not be construed as limited by the disclosed embodiments only, but understood according to the scope of claims appended hereto and equivalents thereof.

1. A system for estimating the perceived quality of a new product, comprising:
a participant information database which stores therein an amount of virtual currency owned by each of a plurality of participants, and a number of virtual stocks corresponding to each of a plurality of products among which at least one new product is included owned by each participant, matched with respect to a corresponding participant;
a trade log database which stores therein records of the transactions of the virtual stocks;
a virtual stock trading unit which receives an order to sell/buy the virtual stocks from terminals of the plurality of participants, and which, if transactions are completed according to the received orders to sell/buy, records the records of the transactions including information such as types of products corresponding to the virtual stocks of the completed transactions, or the price or amount of stocks traded, in the trade log database, and updates the participant information database according to the completed transactions;
a trade analysis module which estimates a market consensus price of each of the virtual stocks by carrying out a regression analysis using the records of the transactions stored in the trade log database; and
an analysis result providing unit which normalizes the market consensus price and provides a user with a normalized perceived quality.

2. The system of claim 1, wherein the trade analysis module comprises a trade information processing unit which obtains the price differentials of a specific transaction, by obtaining a difference between a trading price and a volume-weighted average price of all the transactions from the initial to the specific transactions, and
the market consensus price of each of the virtual stocks is estimated by carrying out the regression analysis using the trading price and the price differential of each of the transactions of the virtual stocks corresponding to the respective products.

3. The system of claim 2, wherein the trade analysis module estimates the market consensus price of the virtual stocks based on an intercept value which is obtained by carrying out the regression analysis on the trading prices of the respective transactions of the virtual stocks corresponding to the products and the price differential of the transaction immediately before the specific transaction.

4. The system of claim 2, wherein the trade analysis module estimates the market consensus prices of the respective virtual stocks by carrying out the regression analysis using the trading prices of the respective transactions of the virtual stocks corresponding to the products, trading price of the transaction immediately before the specific transaction, price differential of the transaction immediately before the specific transaction, and the price differential of the transaction immediately before the transaction immediately before the specific transaction.

5. The system of claim 4, wherein the trade analysis module obtains value α based on
Pₜ=(1−ρ)·α+ρ·Pₜ₋₁+γ·(DIFFₜ₋₁−ρ·DIFFₜ₋₂)+v_{i,t} [Mathematical expression 1]
where Pₜ refers to the trading price of the (t) th transaction, and DIFF refers to the price differential of the (t) th transaction, and estimates the value α as the market consensus price of the virtual stock.

6. The system of claim 1, further comprising:
a product information database which stores therein product information regarding the plurality of products; and
an information providing unit which receives from the terminals of the participants a request for the product information of one of the plurality of products or the information of the transactions of the virtual stock corresponding to the product, and as a response, checks the product information database or the trade log database for the product information or the information of the transactions and sends the information to the terminals of the participants.

7. A method for estimating a perceived quality of a new product, comprising:
storing in a participant information database an amount of virtual currency owned by each of a plurality of participants, and a number of virtual stocks corresponding to each of a plurality of products among which at least one new product is included owned by each participant, matched with respect to a corresponding participant;
receiving an order to sell/buy the virtual stocks from terminals of the plurality of participants, and if transactions are completed according to the received orders to sell/buy, recording the records of the transactions including information such as types of products corresponding to the virtual stocks of the completed transactions, or price or amount of stocks traded, in a trade log database, and updating the participant information database according to the completed transactions;
estimating a market consensus price of each of the virtual stocks by carrying out a regression analysis using the records of the transactions stored in the trade log database; and
normalizing the market consensus price and providing a user with a normalized perceived quality.

8. The method of claim 7, wherein the estimating the market consensus price comprises obtaining the price differentials of a specific transaction, by obtaining a difference between a trading price and a volume-weighted average price of all the transactions from the initial to the specific transactions, and
estimating the market consensus price of each of the virtual stocks by carrying out the regression analysis using the trading price and the price differential of each of the transactions of the virtual stocks corresponding to the respective products.

9. The method of claim 8, wherein the estimating the market consensus price comprises estimating the market consensus price using an intercept value which is obtained by carrying out the regression analysis on the trading prices of the respective transactions of the virtual stocks corresponding to the products and the price differential of the transaction immediately before the specific transaction.

10. The method of claim 8, wherein the estimating the market consensus prices comprises carrying out the regression analysis using the trading prices of the respective transactions of the virtual stocks corresponding to the products, trading price of the transaction immediately before the specific transaction, price differential of the transaction immediately before the specific transaction, and the price differential of the transaction immediately before the transaction immediately before the specific transaction.

11. The method of claim 10, wherein the estimating the market consensus price comprises obtaining a value α based on
Pₜ=(1−ρ)·α+ρ·Pₜ₋₁+γ·(DIFFₜ₋₁−ρ·DIFFₜ₋₂)+v_{i,t} [Mathematical expression 1]
where Pₜ refers to the trading price of the (t) th transaction, and DIFF refers to the price differential of the (t) th transaction, and estimating the value α as the market consensus price of the virtual stock.

12. The method of claim 7, further comprising:
storing in a product information database product information regarding the plurality of products; and
receiving from the terminals of the participants a request for the product information of one of the plurality of products or the information of the transactions of the virtual stock corresponding to the product, and as a response, checking the product information database or the trade log database for the product information or the information of the transactions and sending the information to the terminals of the participants.

13. A computer-readable recording medium comprising a recording therein a program to execute the method of claim 7.

14. A computer-readable recording medium comprising a recording therein a program to execute the method of claim 8.

15. A computer-readable recording medium comprising a recording therein a program to execute the method of claim 9.

16. A computer-readable recording medium comprising a recording therein a program to execute the method of claim 10.

17. A computer-readable recording medium comprising a recording therein a program to execute the method of claim 11.

18. A computer-readable recording medium comprising a recording therein a program to execute the method of claim 12.
